(19) United States
(12) Patent Application Publication
(10) Pub. No.: US 2018/0323596 A1
(43) Pub. Date: Nov. 8, 2018

(54) PYLON SYSTEM AND METHOD FOR EXTENDING THE ELECTRICAL TRANSMISSION CAPACITY OF A PYLON SYSTEM

(71) Applicant: Innogy SE, Essen (DE)

(72) Inventor: Daniel BARTMINN, Elmshorn (DE)

(21) Appl. No.: 15/773,408

(22) PCT Filed: Oct. 21, 2016
(86) PCT No.: PCT/EP2016/075405

§ 371 Date: May 3, 2018

(30) Foreign Application Priority Data
Nov. 3, 2015 (DE) 10 2015 221 553.9

(51) Int. Cl. H02G 7/14

(52) U.S. Cl. CPC H02G 7/14

(57) ABSTRACT

The present invention discloses a pylon system having at least two pylons to each of which at least one insulator is fitted, and having at least one first overhead-line conductor, suspended from each of the insulators, that is tensioned between the at least two pylons, characterized in that the pylon system comprises at least one second overhead-line conductor that is suspended from the respective insulators and is in direct electrical contact with the first overhead-line conductor at least in sections. Further, the present invention discloses a method for extending the electrical transmission capacity of a pylon system that comprises at least two pylons and at least one first overhead-line conductor tensioned between the pylons, wherein the first overhead-line conductor is fitted to a respective insulator mounted on the pylon, the method comprising a method step for fitting a second overhead-line conductor to the two pylons such that the second overhead-line conductor is in direct electrical contact with the first overhead-line conductor at least in sections.

The present invention relates to a pylon system and to a method for extending the electrical transmission capacity of a pylon system.

Pylon systems comprise a plurality of pylons, which may also be termed electricity pylons, for the suspension of overhead electrical power lines, also termed overhead line conductors. Arranged on the electricity pylons are insulators, which are arranged between the respective pylons and the overhead line conductors, the overhead line conductors being suspended from the insulators, such that the pylons are electrically isolated from the overhead line conductors.

Pylon systems are used to transmit electrical energy, including over large distances. In particular, in the case of electrical energy obtained by means of renewable energy sources such as, for example, wind power, the energy generating installations are frequently located at a great distance from the energy consumers, for example energy-intensive industrial installations. In the case of expansion and/or extension of the energy generating installations, more electrical energy must be transported. Consequently, it is desirable to be able to transmit more electrical energy via existing pylon systems.

In the case of pylon systems known from the prior art, the overhead line conductors usually have a circular cross section. The overhead line conductors in this case are subjected, inter alia, to wind loads that are transmitted to the pylons. To increase the electrical transmission capacity of the pylon systems, it is necessary to increase the cross sections of the overhead line conductors, resulting in correspondingly proportionally increased wind loads on the overhead line conductors and on the pylons. An expansion of the electrical transmission capacity of existing pylon systems is thus not easily achievable.

The present invention is based on the object of providing a pylon system that has an increased electrical transmission capacity, and that is subjected to reduced wind loads relative to its electrical transmission capacity. The present invention is additionally based on the object of providing a method for extending the electrical transmission capacity of an existing pylon system.

The object on which the present invention is based is achieved by a pylon system having the features of claim 1. Advantageous developments are described in the claims dependent on claim 1. In addition, the object on which the present invention is based is achieved by a method for extending the electrical transmission capacity of a pylon system having the features of claim 10. Advantageous embodiments of the method are described in the claims dependent on claim 10.

More precisely, the object on which the present invention is based is achieved by a pylon system comprising at least two pylons, attached to each of which is at least one insulator, wherein the pylon system additionally comprises at least one first overhead line conductor, suspended from each of the insulators, that is tensioned between the at least two pylons. The pylon system additionally comprises at least one second overhead line conductor that is suspended from the respective insulators and is in direct electrical contact with the first overhead line conductor, at least in sections.

The second overhead line conductor in this case is designed to transmit the same current phase as the first overhead line conductor. Clearly, the pylon system according to the invention may preferably have a number of first overhead line conductors and second overhead line conductor corresponding to the number of current phases.

The pylon system according to the invention has an increased electrical transmission capacity since, owing to the second overhead line conductor, which transmits the same electrical current phase as the first overhead line conductor, the effectively available conductor cross section is increased. In this case, the wind load upon the pylons is not increased proportionally, but is under-proportional in relation to the available conductor cross sections of the first overhead line conductors and second overhead line conductors.

Preferably, the first overhead line conductor and the second overhead line conductor are each separately suspended from the respective insulators. This offers the advantage that it is possible for the first and/or the second overhead line conductor to be replaced separately, without the necessity of replacing the respectively other overhead line conductor. Consequently, the servicing of the pylon system according to the invention can be performed more easily and more efficiently.

Further, preferably, the pylon system is realized in such a manner that the first overhead line conductor is connected to the second overhead line conductor, between the respective pylons, by means of at least one holding clamp.

The positioning of the second overhead line conductor in relation to the first overhead line conductor can thereby be fixed in an improved manner, such that, depending on the wind direction, the overhead line conductors provide each other with a wind shadow, with the result that the wind load upon the respective overhead line conductors, and thus on the pylons, is reduced. Moreover, the provision of the holding clamps ensures the electrical contact between the first overhead line conductor and the second overhead line conductor.

Further, preferably, the pylon system is realized in such a manner that the second overhead line conductor is arranged, along its longitudinal extent, horizontally next to the first overhead line conductor.

This further reduces the wind load upon the respective overhead line conductors, and thus upon the pylons. This is because winds, to which the overhead line conductors are subjected, are usually horizontal in their course, such that, depending on the wind direction, the overhead line conductors provide each other with a wind shadow. A horizontal arrangement of the second overhead line conductor next to the first overhead line conductor can even reduce the aerodynamic drag, since the cross-sectional shape of the conductor system, consisting of the first overhead line conductor and the second overhead line conductor, is similar to an ellipsoid, and therefore has a lesser coefficient of drag than a line that has a circular cross section.

Further, preferably, the pylon system is realized in such a manner that the second overhead line conductor wraps in the manner of a spiral around the first overhead line conductor, along the longitudinal extent of the first overhead line conductor of the latter.

As a result of the first overhead line conductor being wound around, in the manner of a spiral, by the second overhead line conductor, the total aerodynamic drag of the conductor system, composed of the first overhead line conductor and the second overhead line conductor, is reduced. Further, a tendency toward eddy formation, resulting from the wind impinging laterally upon the conductor system, composed of the first overhead line conductor and the second overhead line conductor, is reduced, such that the wind load upon the conductor system is thereby further reduced.

Preferably, the pylon system is realized in such a manner that the first overhead line conductor and/or the second overhead line conductor each has/have a circular cross section. The ratio of cross-sectional area to outer surface of a circular overhead line conductor is optimal.

Further, preferably, the pylon system is realized in such a manner that the second overhead line conductor has an outer contour portion that is concave in cross section, wherein the second overhead line conductor is arranged with respect to the first overhead line conductor in such a manner that the concave outer contour portion is arranged opposite a convexly realized outer contour portion of the first overhead line conductor.

The second overhead line conductor in this case preferably sits closely against the first overhead line conductor. Preferably, the concave outer contour portion of the second overhead line conductor is realized as a contact portion. In this case, the convexly realized outer contour portion of the first overhead line conductor is then likewise realized as a contact portion. The concave contact portion of the second overhead line conductor is then in direct electrical contact with the convexly realized outer contact portion of the first overhead line conductor.

In the case of such a realization of the conductor system, composed of the first overhead line conductor and the second overhead line conductor, the positioning of the second overhead line conductor in relation to the first overhead line conductor is improved, owing to the second overhead line conductor sitting closely against the first overhead line conductor. Moreover, the coefficient of drag of the thus formed conductor system is reduced.

Further, preferably, the pylon system is realized in such a manner that a space between the first overhead line conductor and the second overhead line conductor is filled by means of a filling compound.

Provision of a filling compound in the space between the first overhead line conductor and the second overhead line conductor further reduces the coefficient of drag of the conductor system formed by the first overhead line conductor and the second overhead line conductor. In addition, eddy formation, resulting from wind impinging laterally upon the conductor system, is counteracted. Both reduce the wind load upon the conductor system, and thus the wind load upon the pylons to which the first overhead line conductor and the second overhead line conductor are fastened. In addition, the filling compound may be used to fasten the second overhead line conductor to the first overhead line conductor. An epoxy resin, a silicone elastomer (e.g. silicone and/or fluorosilicone), ethylene propylene diene monomer rubber (EPDM), polyurethane and/or nitrile butadiene rubber (NBR), for example, may be used as material for the filling.

Further, preferably, the pylon system is realized in such a manner that the filling compound is electrically conductive. The conductor cross section of the conductor system, composed of the first overhead line conductor and the second overhead line conductor, is thereby further increased, such that the ratio of cross-sectional area to the outer surface of the conductor system is further improved.

An epoxy resin, a silicone elastomer (e.g. silicone and/or fluorosilicone), ethylene propylene diene monomer rubber (EPDM), polyurethane and/or nitrile butadiene rubber (NBR) may be used, for example, as material for the filling, and the respective filling material may be provided with electrically conductive constituents, such as metal strands and/or carbon and/or nickel and/or nickel-plated graphite pellets and/or silver-coated glass pellets and/or silver-coated nickel particles and/or silver-coated aluminum particles and/or silver-coated copper particles and/or silver.

The object on which the present invention is based is also achieved by a method for extending the electrical transmission capacity of a pylon system, wherein the pylon system comprises at least two pylons and at least one first overhead line conductor tensioned between the pylons, wherein the first overhead line conductor is attached to a respective insulator fastened to the pylon, wherein the method comprises a method step for attaching a second overhead line conductor to the two pylons in such a manner that the second overhead line conductor is in direct electrical contact with the first overhead line conductor, at least in sections.

By means of the method according to the invention, the electrical transmission capacity of the pylon system can be increased without the wind load upon a conductor system, composed of the first overhead line conductor and the second overhead line conductor, necessarily increasing proportionally in relation to the conductor cross-sectional area of the conductor system. Installing overhead line conductors on the pylon system may be performed by use of a spindle carriage, which is suspended on the first overhead line conductor and it moves along the first overhead line conductor and, in so doing, fastens the second overhead line conductor to the first overhead line conductor.

Preferably, the method comprises a method step for filling a space between the first overhead line conductor and the second overhead line conductor with filling compound. The filling of the space with the filling compound may be effected, for example, by a following carriage or a following arm of a spindle carriage.

Further advantages, details and features of the invention are disclosed in the following by the explained exemplary embodiments. There are shown, in detail:

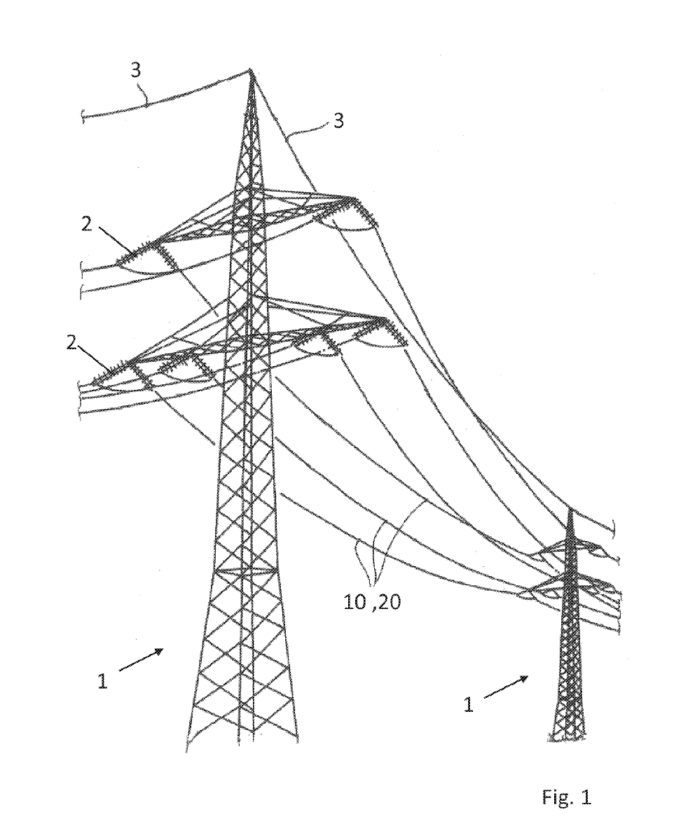

FIG. 1: a schematic representation of a pylon system according to the invention;

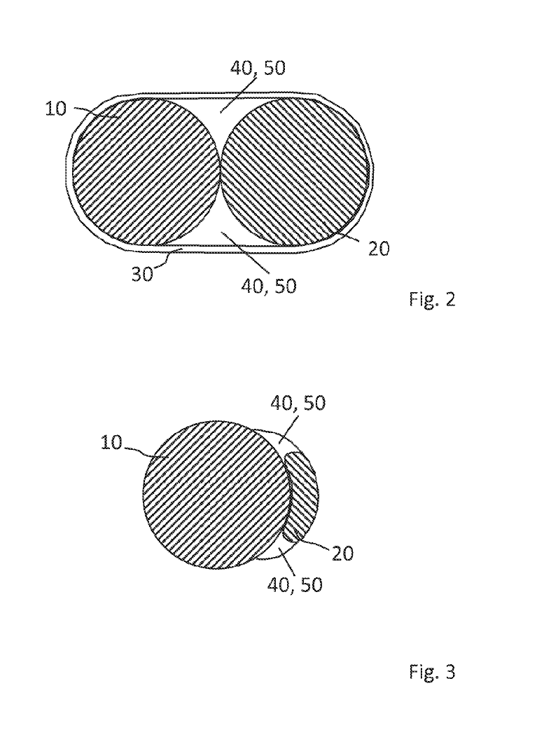

FIG. 2: a schematic sectional representation of a conductor system of a first embodiment of the pylon system according to the invention; and

FIG. 3: a schematic sectional representation of a conductor system of a second embodiment of the pylon system according to the invention.

In the description that now follows, structural elements that are the same, or features that are the same, are denoted by the same references, such that a description relating to a structural element given with reference to one figure also applies to the other figures, such that repeated description is avoided.

A pylon system according to the invention is represented schematically in FIG. 1. The pylon system comprises at least two pylons 1, attached to each of which are a multiplicity of insulators 2, from each of which overhead line conductors 10, 20 are suspended, such that the overhead line conductors 10, 20 are electrically isolated from the electrical pylons 1. Provided at the tip of the pylons 1 is an earthing cable 3, which is tensioned between the pylons 1. The earthing cable 3 in this case serves to absorb voltage peaks that may occur, for example, as a result of a lightning strike.

Although not evident from FIG. 1, the overhead line conductors 10, 20 are realized as two pieces. A first overhead line conductor 10 and a second overhead line conductor 20 are used for electricity transmission. The first overhead line conductor 10 and the second overhead line conductor 20 in this case are in direct electrical contact with each other, at least in sections.

Represented schematically in cross section in FIG. 2 is a conductor system composed of the first overhead line conductor 10 and the second overhead line conductor 20. It can be seen that the second overhead line conductor 20 is in direct electrical contact with the first overhead line conductor 10. It can also be seen from FIG. 2 that the second overhead line conductor 20 is arranged horizontally next to the first overhead line conductor 10, along the longitudinal extent of the overhead line conductors 10, 20. Since the second overhead line conductor 20 is positioned horizontally next to the first overhead line conductor 10, in the case of wind impinging laterally upon the conductor system, composed of the first overhead line conductor 10 and the second overhead line conductor 20, one of the overhead line conductors 10, 20 will be substantially in the wind shadow of the other overhead line conductor 10, 20. The coefficient of drag of the conductor system is thereby reduced, as a result of which the conductor system is subjected to lesser wind loads, which in turn results in a lesser wind loading of the pylons 1.

It can be seen from FIG. 2 that the first overhead line conductor 10 and the second overhead line conductor 20 each have a circular cross section. A space 40 between the first overhead line conductor 10 and the second overhead line conductor 20 is filled by means of a filling compound 50. The filling compound 50 in this case may be an epoxy resin. Preferably, the filling compound 50 is an epoxy resin provided with metal strands, such that the filling compound 50 is electrically conductive. Furthermore, a silicone elastomer, provided with electrically conductive constituents in the form of strands and/or particles, may be used as an electrically conductive filling compound 50. The silicone elastomer may be silicone and/or fluorosilicone. The electrically conductive filling compound 50 may also be EPDM (ethylene propylene diene monomer rubber) and/or polyurethane and/or NBR (nitrile butadiene rubber). The electrically conductive constituents may be carbon and/or nickel and/or nickel-plated graphite pellets and/or silver-coated glass pellets and/or silver-coated nickel particles and/or silver-coated aluminum particles and/or silver-coated copper particles and/or silver. The available line cross section of the conductor system, composed of the first overhead line conductor 10, the second overhead line conductor 20 and the filling compound 50, can thereby be further increased. At the same time, the coefficient of drag of the conductor system is reduced by filling the space 40 between the first overhead line conductor 10 and the second overhead line conductor 20, since eddy formation resulting from laterally impinging wind is counteracted.

It can also be seen from FIG. 2 that the first overhead line conductor 10 and the second overhead line conductor 20 are connected to each other by means of a holding clamp 30. Between two pylons, the overhead line conductors 10, 20 may be connected by a plurality of holding clamps 30.

FIG. 3 shows a schematic sectional representation of a conductor system of a further embodiment of the pylon system according to the invention. The first overhead line conductor 10 has a circular cross section, such that the first overhead line conductor 10 has an outer contour portion 11 that is realized convexly in cross section. The second overhead line conductor 20, by contrast, also has an outer contour portion 21 that is concave in cross section. The concave outer contour portion 21 in this case sits closely against the convexly realized outer contour portion 11 of the first overhead line conductor 10. It can be seen from FIG. 3 that a direct contact is realized between the first overhead line conductor 10 and the second overhead line conductor 20 by the convexly realized outer contour portion 11 of the first overhead line conductor 10 and the concavely realized outer contour portion 21 of the second overhead line conductor 20. The first overhead line conductor 10 and the second overhead line conductor 20 are thus electrically connected to each other via the convex outer contour portion 11, which may also be referred to as a first contact region 11 of the first overhead line conductor 10, and the concave outer contour portion 21, which may also be referred to as a second contact region 21 of the second overhead line conductor 20.

It can also be seen from FIG. 3 that the space 40 between the first overhead line conductor 10 and the second overhead line conductor 20 is filled by a filling compound 50. The filling compound 50 in this case is preferably an epoxy resin, a silicone elastomer (e.g. silicone and/or fluorosilicone), EPDM, polyurethane and/or NBR. Further, preferably, the filling compound 50 is provided with electrically conductive constituents such as metal strands, carbon and/or nickel and/or nickel-plated graphite pellets and/or silver-coated glass pellets and/or silver-coated nickel particles and/or silver-coated aluminum particles and/or silver-coated copper particles and/or silver, such that the filling compound 50 can also be used for conducting electricity, with the result that the line cross section of the conductor system, composed of the first overhead line conductor 10, the second overhead line conductor 20 and the filling compound 50, is further increased. In addition, the coefficient of drag of the conductor system is reduced by filling the space 40 between the first overhead line conductor 10 and the second overhead line conductor 20, as a result of which the wind loads upon the conductor system, and thus upon the pylons, is reduced. Furthermore, turbulences due to wind impinging laterally upon the conductor system are reduced.

Although not evident from FIG. 3, the second overhead line conductor 20 may preferably wrap in the manner of a spiral around the first overhead line conductor 10, along the longitudinal extent of the first overhead line conductor 10. Such an arrangement of the second overhead line conductor 20 in respect of the first overhead line conductor 10 further reduces eddy formation of the conductor system, composed of the first overhead line conductor 10 and the second overhead line conductor 20. The wind loads upon the conductor system and upon the pylon system are thereby reduced.

### LIST OF REFERENCES

1 pylon
2 insulator
3 earthing cable
10 first overhead line conductor
11 convex outer contour portion/contact region (of the first overhead line conductor)
20 second overhead line conductor
21 concave outer contour portion/contact region (of the second overhead line conductor)
30 holding clamp
40 space (between first overhead line conductor and second overhead line conductor)
50 filling compound

What is claimed is:

1. A pylon system having at least two pylons, attached to each of which is at least one insulator, and having at least one first overhead line conductor, suspended from each of the insulators, that is tensioned between the at least two pylons, wherein the pylon system comprises at least one second overhead line conductor that is suspended from the respective insulators and is in direct electrical contact with the first overhead line conductor, at least in sections.

2. The pylon system as claimed in claim 1, wherein the first overhead line conductor and the second overhead line conductor are each separately suspended from the respective insulators.

3. The pylon system as claimed in claim 1, wherein the first overhead line conductor is connected to the second overhead line conductor, between the pylons, by at least one holding clamp.

4. The pylon system as claimed in claim 1, wherein the second overhead line conductor is arranged, along its longitudinal extent, horizontally next to the first overhead line conductor.

5. The pylon system as claimed in claim 1, wherein the second overhead line conductor wraps in the manner of a spiral around the first overhead line conductor, along the longitudinal extent of the first overhead line conductor of the latter.

6. The pylon system as claimed in claim 1, wherein the first overhead line conductor and the second overhead line conductor each have a circular cross section.

7. The pylon system as claimed in claim 1, wherein the second overhead line conductor has an outer contour portion that is concave in cross section, wherein the second overhead line conductor is arranged with respect to the first overhead line conductor in such a manner that the concave outer contour portion is arranged opposite a convexly realized outer contour portion of the first overhead line conductor.

8. The pylon system as claimed in claim 1, wherein a space between the first overhead line conductor and the second overhead line conductor is filled by a filling compound.

9. The pylon system as claimed in claim 8, wherein the filling compound is electrically conductive.

10. A method for extending the electrical transmission capacity of a pylon system that comprises at least two pylons and at least one first overhead line conductor tensioned between the pylons, wherein the first overhead line conductor is attached to a respective insulator fastened to the pylon, wherein the method comprises a method step for attaching a second overhead line conductor to the two pylons in such a manner that the second overhead line conductor is in direct electrical contact with the first overhead line conductor, at least in sections.

11. The method as claimed in claim 10, wherein the method comprises a method step for filling a space between the first overhead line conductor and the second overhead line conductor with filling compound.
